(19) United States
(12) Patent Application Publication
(10) Pub. No.: US 2023/0128887 A1
(43) Pub. Date: Apr. 27, 2023

(54) FOLDABLE TEST TUBE RACK

(71) Applicant: Zhejiang Orient Gene Biotech Co., Ltd, Huzhou (CN)

(72) Inventor: Jianqiu FANG, Huzhou (CN)

(21) Appl. No.: 17/518,236

(22) Filed: Nov. 3, 2021

(30) Foreign Application Priority Data
Oct. 21, 2021 (CN) 2021112269413
Oct. 21, 2021 (CN) 2021225380293

(51) Int. Cl. B01L 9/06

(52) U.S. Cl. CPC B01L 9/06; B01L 2200/025; B01L 2200/04; B01L 2200/0615; B01L 2300/0609; B01L 2300/126; B01L 2200/12

(57) ABSTRACT

The application is related to a test tube rack, and the test tube rack comprises a first supporting surface and a second supporting surface. The test tube rack further comprises a first hole used for inserting a test tube. The first supporting surface and the second supporting surface can be folded. Such test tube rack can be subject to folding shrink packaging when being packaged and is opened when being used, so that a test tube is inserted to operate.

### CROSS-REFERENCE TO RELATED APPLICATIONS

This application claims the priority of prior applications as follows, Application No.: 202111226941.31, filed on Oct. 21, 2021; Application No.: 202122538029.3, filed on Oct. 21, 2021: the contents disclosed in which are as part of the present invention.

### TECHNICAL FIELD

The present invention relates to a test tube rack used for placing test tubes, in particular to a tube rack used for placing a cracking tube in the field of rapid diagnosis.

### BACKGROUND

Introduction of background art below is merely introduction of some background knowledge, which does not limit the present invention.

At present, a lot of detection apparatuses used for detecting whether a sample contains analyzed substance or not are used in hospitals or homes. The detection apparatuses applied to rapid diagnosis include one or more detection reagent strips, for example, early pregnancy detection and drug abuse detection. The detection apparatus for rapid diagnosis is quite convenient and can gain a detection result on the detection reagent strips within about one minute or at most ten minutes.

At present, infectious disease detection, in particular virus detection, becomes more and more generalized and routinized. This type of detection is a necessary detection item as routing inspection by a professional inspection body, and family operation becomes more and more generalized. Like early pregnancy detection in early stage, infectious disease detection becomes more and more generalized and approaches to family detection. With respect to family detection of infectious disease, for example, virus detection of flu and coronavirus disease, including routine other family detection as well without doubt, it is usually necessary to split viruses or a bacteria in advance or pre-treat a sample and then carry out subsequent detection. With respect to infectious disease detection, an important port is to split the viruses or bacteria in the sample, so that a split fragment antigen is detected. Off course, if it is other sample, it may be necessary to pre-treat the sample, for example, some buffer solutions are treated. In family detection or in some small clinic environments, a test tube for placing a splitting solution or a solution that treats the sample is needed in timely detection. The test tube is vertically placed on a table-board, for example, a table top of a small test table or a table top in a family, the sample and a swab with the sample, for example, a collector that collects a cotton swab of the sample are placed in the test tube or a tube body, so that a liquid in the tube body is in contact with the sample, and therefore, the sample is treated. After treatment is finished, the splitting solution or the solution that treats the sample is detected subsequently or is subject to other treatments.

With respect to the table-board for placing the test tube, a rack is usually needed, the test tube is vertically placed, the rack is usually provided to a user by a reagent supplier, and the user does not prepare such a rack usually. Conventional test tube racks are formed by plastics at one time. It is inconvenient to transport the test tube racks as the test tube racks occupy volume in manufacturing and packaging and have weights. The cost is increased. A lot of plastic products lead to environmental pollution, which increases the cost of subsequent environmental-friendly treatment.

In order to solve the abovementioned technical problems, it is needed to be improved, and another way is provided to overcome defects in the prior art.

### SUMMARY

In order to improve an existing test tube rack, the invention provides a test tube rack. The test tube rack is very small in occupied space in packaging, and is substantially in a folded and compressed state. When it is needed to be used, it is opened to form the test tube of a three-dimensional structure to place a test tube, a centrifuge tube or any tube body with solutions. After use, the test tube rack is abandoned disposably. In some implementation modes, the test tube rack is manufactured by hard paper, and in some implementation modes, the test tube rack is manufactured by degradable paper.

Therefore, in a first aspect of the present invention, provided is a test tube rack. The test tube rack includes a first supporting surface and a second supporting surface. The test tube rack further includes a first hole used for inserting a test tube. The first supporting surface and the second supporting surface can be folded. In some implementation modes, the test tube rack further includes a first surface, the first surface is connected with the first supporting surface and the second supporting surface, and the first surface includes the hole. In some implementation modes, the first surface is connected with the first supporting surface and the second supporting surface respectively via a broken line and a crease.

In some implementation modes, the supporting surface includes a first supporting surface and a second supporting surface, and a connection between the supporting surface and the first surface includes a fold line or the two supporting surfaces are connected with two ends of the first surface via the fold line. The supporting surface and the first surface can be folded via the fold line, so that the volume is reduced. When it is needed to be used, it is opened via the fold line to form a three-dimensional rack body structure capable of placing the tube body. The fold line therein can be understood as a crease, a fold position, a crease line, a broken line, a broken line position and the like. Therefore, the first supporting surface and the second supporting surface are used to support the first surface. When it is opened to stand, the first surface has an operating surface or the supporting surface is a distance from the bottom. Thus, when the test tube or the tube body is inserted into the hole, the tube body is kept in an erecting or standing gesture. After the tube body is exhausted, when the tube body is taken out from the hole, the test tube rack is put away via the fold line.

In some implementation modes, the test tube rack further includes a base surface, the base surface is connected with the supporting surface, and the base surface is located below the first surface. In some implementation modes, the base surface is connected with the supporting surface via the crease and the broken line. In some implementation modes, one end of the base surface is connected with one end of the supporting surface via the fold line and the crease, and the other end of the supporting surface is connected with the first surface via the fold line and the crease. In some implementation modes, one end of the base surface is connected with one end of the first supporting surface via the fold line, and the other end of the first supporting surface is connected with the first surface via the fold line or is connected with the first surface constantly. Thus, the base surface and the two supporting surfaces as well as the first surface form a three-dimensional shape, the first surface is used for inserting the tube body and the base surface is used for stabilizing a distance of the supporting surface, so that the stability of the tube rack is improved. In some implementation modes, the supporting surface is trapezoidal, so that a three-dimensional bodily form shape is formed. The short surface is taken as a surface for inserting the test tub hole and the long surface is taken as the base, thereby improving the stability of the test tube rack. Certainly, it is merely a preferred mode, and it may be any mode, for example, a three-dimensional cube and cuboid formed by the first surface, the supporting surface and the base surface.

In some implementation modes, when the base surface is opened, the base surface is parallel to or substantially parallel to the first surface. In some implementation modes, the length of the base surface is greater than that of the first surface. When the test tube rack is opened from the folded form, a section forms a trapezoidal form, thereby, improving the stability of the test tube. In some implementation modes, the width of the base surface is equal to or substantially equal to that of the first surface.

In some implementation modes, a first steady surface is further arranged between the base surface and the first surface. Two ends of the steady surface are respectively connected with the first supporting surface or the second supporting surface. Thus, when the whole test tube rack stands, the test tube rack is more stable and is not prone to toppling. In some implementation modes, the steady surface further includes an insertion hole, and the insertion hole and the insertion hole in the first surface are located on a same central axis substantially. Thus, when the test tube is inserted into the insertion hole, there are two holes through which the test tube is inserted. The test tube body is more stable.

In some implementation modes, the first surface and one or more of the base surface, the steady surface or the first surface further includes a fold line. The first surface, the base surface or the steady surface are further folded as the fold line is folded, so that the whole test tube rack is further folded and shrunk. When the whole test tube rack is folded, it is very small in thickness and is nearly free of thickness unless a sum of the thicknesses of the several surfaces themselves. The thickness of the folded test tube rack is the thickness of the two supporting surfaces that are overlapped. In some implementation modes, the fold line is located in a center line position of the first surface. In some implementation modes, the fold lines of the base surface and the steady surface are located in the center line positions respectively. In some implementation modes, the first surface is folded inwards toward a direction close to the steady surface or the base via the fold line. When there is the steady surface or the base surface, and when there is no steady surface or base surface, the first surface is folded downwards by way of the broken line. Thus, the length of the test tube folded in the vertical direction is reduced, and the test tube is transported in a packaged manner, so that the space is saved. In some implementation modes, similarly, when there is the base surface and the base surface is folded via the broken line, the folding direction is inwards or toward the direction close to the first surface, and therefore, the length of the whole test tube rack folded in the vertical direction is further reduced. The folding directions are merely some preferred directions, and it is certainly that the first surface or the second surface is folded outwards. The opening and shrinking states are realized by folding and opening the broken line.

In some implementation modes, the whole test tube rack is an integer or a whole plane which is folded and formed via the fold line. Therefore, it is convenient to process and design. One plane is folded to form a three-dimensional structure, and the three-dimensional structure can be shrunk and opened via the fold line. In some implementation modes, the whole plane is formed by folding some hard paper and sheets. In some implementation modes, in order to make the whole structure more stable, some splicing surfaces can be arranged. For connection between the first surface, the base surface or the steady surface, the splicing surfaces are spliced one another. In some implementation modes, the base surface is further connected with the splicing surface, the splicing surface is spliced to the second supporting surface, and the splicing surface is connected with the base edge via the crease line. In some implementation modes, two ends of the steady surface are provided with the splicing surfaces that are spliced in the two supporting surfaces respectively, and thus, a test tube rack of a fixed structure is formed. Certainly, the first surface, the supporting surface, the base surface, the steady surface and the splicing surface are areas divided on the whole plane, and a three-dimensional test tube rack structure is formed via the fold line.

In some implementation modes, when the first surface is provided with one insertion hole, one test tube can be inserted. When it is necessary to insert the plurality of test tubes at the same time, it is expected to receive insertion of a plurality of tube bodies by a plurality of different insertion holes. At the moment, it is expected to be a single body where the plurality of insertion holes repeatedly formed in different directions. For example, the insertion holes are formed longitudinally in the first surface. The first surface is lengthened toward two ends, the width of the first surface is invariable and the length of the first surface is increased and the first surface extends toward a connecting segment, so that the plurality of insertion holes can be formed in the first surface. Similarly, when it includes the base or includes the steady surface, the first surface extends towards two ends, so that the plurality of insertion holes can be formed.

In some other directions, it is expected to expand transversely, that is, expand along the direction of the supporting surface. When the supporting surface is vertical to the first surface or is in vertical relation to the first surface, it is actually a structure of a cube or a cuboid. The expansion mode is as same as the longitudinal first surface, so that the transverse direction is extended.

The present invention has the beneficial effects:

By adopting the structure, the folded tube body rack can be provided. The tube rack can be folded and shrunk, and can be opened and extended to a three-dimensional shape to support the test tube. Thus, the weight of the test tube rack is alleviated and the packaging space is reduced. If it is manufactured by a paper material, the test tube rack is simple and convenient to manufacture and low in cost, and the environmental pollution (relative to a plastic bracket) is reduced.

### BRIEF DESCRIPTION OF THE DRAWINGS

FIG. 1 is a structural schematic diagram of a paperboard in an implementation for manufacturing a test tube rack capable of being folded and shrunk as an example of the present invention.

FIGS. 2A-2E illustrate a test tube rack of a specific implementation mode. FIG. 2A is a test tube rack in the folded and shrunk state. FIG. 2B is a test tube rack in an unfolded state. FIG. 2C is another test tube rack in an opened state. FIG. 2D is a paperboard for manufacturing the test tube rack shown in FIG. 2A. FIG. 2E is a structural schematic diagram of expanding a plurality of single test tube racks.

FIGS. 3A-3G illustrate a test tube rack of another specific implementation mode. FIG. 3A is a test tube rack in the folded and shrunk state. FIG. 3B is a test tube rack in an unfolded state. FIG. 3C is another test tube rack in an opened state. FIG. 3D is a paperboard for manufacturing the test tube rack shown in FIG. 2A. FIG. 3E is a schematic diagram of the folded and shrunk test tube rack in another state, FIG. 3F is another state diagram of a folded and opened test tube rack, and FIG. 3G is a three-dimensional structural schematic diagram with a steady surface located in a middle position of the supporting surface.

FIGS. 4A-4D illustrate a process schematic diagram of the paperboard shown in FIG. 1 folded via the broken line. FIG. 4A is a folding schematic diagram of the third step, FIG. 4B is a folding schematic diagram of the fourth step, FIG. 4C is a folding schematic diagram of the fifth step, and FIG. 4D is a folding schematic diagram of the sixth step.

FIG. 5 is a three-dimensional schematic diagram of the paperboard shown in FIG. 1 folded.

FIG. 6 is a three-dimensional schematic diagram of the paperboard shown in FIG. 1 folded.

FIG. 7 is a left view of the paperboard shown in FIG. 1 folded.

FIG. 8 is a structural schematic diagram of the tube body rack shown in FIG. 5 in the folding and shrinking process or in the shrinking and stretching process.

FIG. 9 is a structural schematic diagram of the tube body rack shown in the FIG. 5 folded and shrunk.

FIG. 10 is a structural schematic diagram of a single test tube rack longitudinally expanded to multiple racks shown in FIG. 5.

FIG. 11 is a structural schematic diagram of a single test tube rack longitudinally expanded to multiple racks shown in FIG. 5.

FIGS. 12A-12C illustrate a three-dimensional structural schematic diagram of the tube body, a sealing membrane and a liquid drop plug, herein FIG. 12A is a structural schematic diagram of a test tube sealed by the sealing membrane, FIG. 12B is a schematic diagram of the sealing membrane, and FIG. 12C is a structural schematic diagram of the liquid drop plug.

FIG. 13 is a structural schematic diagram of a test apparatus.

FIG. 14 is a structural schematic diagram of a single test tube rack transversely expanded to multiple racks shown in FIG. 5.

FIG. 15 is a process diagram of folding two single tube racks by one paperboard.

FIG. 16 is a planar structural schematic diagram of the paperboard of another embodiment with a broken line dividing region.

FIG. 17 is a tube body structure formed by folding the plane shown in FIG. 16.

FIG. 18 is a structural schematic diagram of a single test tube rack longitudinally expanded to multiple tube body connections shown in FIG. 17.

FIG. 19 is a structural schematic diagram of the tube body rack shown in FIG. 17 in the folding and shrinking process or in the shrinking and stretching process.

FIG. 20 is a structural schematic diagram of the tube body rack shown in the FIG. 17 folded and shrunk.

FIGS. 21A-21D illustrate a structural schematic diagram of a foldable tube body of another embodiment, FIG. 21A is an unfolded structural schematic diagram, FIG. 21B is a structural schematic diagram containing a base, FIG. 2C is a structural schematic diagram provided with the steady surface between the base and the hole, and FIG. 21D is a structural schematic diagram short of the base surface.

### DETAILED DESCRIPTION

Further description on the structure involved in the present invention or these used technical terms is made below. Unless otherwise specified, they are understood and explained on the basis of general common terms in the field.

Detection Detection represents that it is assayed or tested whether one substance or material exists or not, for example, including, but not limited to, a chemical substance, an organic compound, an inorganic compound, a metabolite, a drug or a drug metabolite, an organic tissue or a metabolite of the organic tissue, a nucleic acid, a protein or a polymer. In addition, detection represents testing of the quantity of the substance or material. Further, assay further represents immunodetection, chemical detection, enzyme detection and the like.

Sample

A detection apparatus or a collected sample of the present invention includes a biological liquid (for example, a case liquid or a clinic sample). The liquid sample or a liquid specimen or a fluid sample or a fluid specimen can be originated from a solid state sample or a semi-solid state sample, including an excrement, a biological tissue and a food sample. The solid state or semi solid state can be converted into the liquid sample by any proper method, for example, mixing, titrating, macerating, incubating, dissolving or digesting the solid sample in a proper solution (for example, water, a nitrate solution or other buffer solutions) by means of enzymolysis. The biological sample includes samples originated from animals, plants and food, for example, including urine, saliva, blood and components thereof, a spinal fluid, a vaginal secretion, a sperm, an excrement, sweat, an excretion, a tissue, an organ, a culture of a tumor and organ, a cell culture and a medium originated from human or animal. Preferably, the biological sample is urine, and preferably, the biological sample is saliva. The food sample includes a food processed substance, a final product, meat, cheese, spirit, milk and drinking water. The plant sample includes any plant, plant tissue, plant cell culture and medium. An environmental sample is originated from an environment (for example, a liquid sample, a sewage sample, a soil sample, underground water, seawater and a waste liquor sample originated from a lake or other water bodies). The environmental sample further includes sewage or other waste water.

Any analyte can be detected by using a proper detection element or a testing element. Preferably, drug small molecules in saliva and urine are detected. Certainly, regardless of solid state or liquid state, the collector can collect abovementioned samples in any form if the liquids or liquid samples can be absorbed by an absorbing element. The absorbing element herein is commonly prepared from a water absorbing material and is dry in the beginning. The liquid sample or the fluid sample can be absorbed by means of capillary or other characteristics of the material of the absorbing element. The absorbing material can be any material capable of absorbing liquids, for example, a sponge, filter paper, a polyester fiber, a gel, a non-woven fabric, cotton, a polyester film, a yarn and the like. Certainly, the absorbing element is not necessarily prepared from the absorbing material, can be prepared from a non-water absorbing material, and the absorbing element is provided with holes, threads and a cavities. The samples can be collected on the structures. The samples are generally solid or semi-solid samples, and the samples fill the spaces among the threads and the holes or cavities.

Upstream and Downstream

Downstream or upstream is divided relative to a liquid flowing direction, and generally, the liquid flows to a downstream region from upstream. The liquid from the upstream region is received in the downstream region, and the liquid can further flow to the downstream region along the upstream region. Herein, it is divided according to the liquid flowing direction, for example, on some materials where the liquid flows by means of a capillary force, the liquid can flow toward a direction opposite to the gravity, and at the time, the upstream and the downstream are divided according to the liquid flowing direction.

Gas Communication or Liquid Communication

Gas communication or liquid communication means that the liquid or the gas can flow from one place to another place, and in the flowing process, a guiding role may be played through some physical structures. Flowing through the physical structures generally means that the liquid flows through the surfaces of the physical structures or the inner spaces in the structure flow to another place passively or actively. Flowing passively generally refers to flowing due to an external force, for example, flowing under a capillary action. Flowing herein may be flowing of the liquid or the gas due to self action (gravity or pressure) or passive flowing. Communication herein by no means represents that there is the liquid or the gas. It is indicated only in some circumstances a connecting relation or state between two objects. If there is the liquid, the liquid can flow from one object to the other one. It herein refers to a state that the two objects are connected. On the contrary, if there is no liquid communication state or gas communication state between the two objects and the liquid in one object or on the one object, the liquid cannot flow to the other one object or on the other one object. Such as state is non-communicated: a non-liquid or gas communicated state.

Test Element

The so called test element means that elements capable of detecting whether the specimens or samples contain interesting analytes can be called test elements. The detection can be based on any technical principles, for example, immunological, chemical, electric, optical, molecular, nucleic and physical principles. The test element can be selected from a transverse flowing detection test strip which can detect various analytes. Certainly, other proper test element can apply the present invention, too.

Various test elements can be combined together and can be applied to the present invention. The detection test strip is one of forms. The detection test strip for analyzing the analytes in the specimens (for example, drug or metabolite reflecting physical condition) can be various forms, for example, immunoassay or chemical analysis. The detection test strip can be in an analytical mode of a non-competition law or a competition law. The detection test strip generally contains a water absorbing material with a specimen adding region, a reagent region and a test region. The specimens are added into the specimen region and flow to the reagent region by means of action of a capillary tube. In the reagent region, if there is the analytes, the specimen and a reagent are combined. Then, the specimen flows to the detection region continuously. Some other reagents, for example, molecules specifically combined with the analytes are fixed in the detection region. The reagents are reacted with the analytes (if exist) in the specimen, and the analytes are combined in the region or are combined with some reagent in the reagent region. A marker for displaying a detection signal has a marker region separated from the reagent region.

The typical non competition law analytical mode is that if the specimen contains the analytes, a signal is generated, and if not, no signal is generated. In the competition law, if the analytes are not in the specimen, the signal is generated, and if no, no signal is generated.

The test element can be detection test paper which can be made from a water absorbing or non-water absorbing material. The detection test paper can include various materials for transferring the liquid specimen. The material of one detection test paper covers the other material, for example, the filter paper covers a nitrocellulose membrane. One region of the detection test paper can be one or more materials and the other region select one or more different materials. The detection test paper can be adhered to some support or hard surface for improving the strength of taking the detection test paper.

The analytes are detected by a signal generation system. By means of one or more enzymes specifically reacted with the analytes, compositions of one or more signal generation systems are fixed to the analyte detection region of the detection test paper by means of a method of fixing the specifically combined substances to the detection test paper. A substance generating signals can be in the specimen adding region, the reagent region or the detection region, or the whole detection test paper. The substance can fill one or more materials of the detection test paper. A solution containing a signifier is added to the surface of the test paper or one or more materials of the test paper are immersed in the solution containing the signifier. The test paper where the solution containing the signifier is dried.

The regions of the detection test paper can be arranged according to the following modes: the specimen adding region, the reagent region, the detection region, a control region, a region for determining whether the specimen is adulterated or not and a liquid sample absorbing region. The control region is located behind the detection region. All the regions can be arranged on one test paper only prepared from one material. Different regions can be made from different materials. The regions can be in direct contact with the liquid specimen or different regions are arranged according to the flowing direction of the liquid specimen, and the tail ends of the regions are connected and superposed with the front ends of the other regions. The used material can be a material with a better water absorbing property, for example, filter paper, a glass fiber or a nitrocellulose membrane and the like. The detection test paper can be in other forms.

A generally common reagent strip is a nitrocellulose membrane reagent strip, i.e., the detection region includes the nitrocellulose membrane, and a detection result is displayed by fixing specifically combined molecules to the nitrocellulose membrane. The detection region can further be the nitrocellulose membrane or a nylon membrane and the like. For example, the reagent strips or the apparatuses containing the reagent strips described in some patents below: U.S. Pat. Nos. 4,857,453; 5,073,484; 5,119,831; 5,185,127; 5,275,785; 5,416,000; 5,504,013; 5,602,040; 5,622,871; 5,654,162; 5,656,503; 5,686,315; 5,766,961; 5,770,460; 5,916,815; 5,976,895; 6,248,598; 6,140,136; 6,187,269; 6,187,598; 6,228,660; 6,235,241; 6,306,642; 6,352,862; 6,372,515; 6,379,620; and 6,403,383. The test strips and similar apparatus with the test strips disclosed in the abovementioned patents can be applied to detecting analytes in the test element or the detection apparatus, for example, detection of the analytes in the specimen.

The detection reagent strips applied to the present invention can be generally called lateral flow test strips, the specific structures and detection principles of which are known technologies to those of ordinary skilled in the art. A common detection reagent strip includes the specimen collecting region or the specimen adding region, a marking region, a detection region and a water absorbing region. The specimen collecting region includes a specimen receiving pad, the marking region includes a marking pad, and the water absorbing region can include a water absorbing pad, and the detection region can include a necessary chemical substance capable of detecting whether the analytes are comprised, for example, an immunoreagent or an enzyme chemical reagent. A generally common detection reagent strip is a nitrocellulose membrane reagent strip, i.e., the detection region includes the nitrocellulose membrane, and a detection result is displayed by fixing specifically combined molecules to the nitrocellulose membrane. The detection region can further be the nitrocellulose membrane or a nylon membrane and the like. Certainly, the downstream of the detection region can further include a detection result control region, and generally, the control region and the detection region appear in form of transverse line which is a detection line or a control line. The detection reagent strip is a conventional reagent strip, and certainly, it can be the reagent strip of other types for detection by means of capillary action. In addition, the common detection test strip is provided with a dry chemical reagent component, for example, a solid antibody or other reagents. When encountering a liquid, the liquid flows along with the reagent strip by means of the capillary action. Along with flowing, the dried reagent component is dissolved in the liquid, so that the dry reagent in the region is reacted in the next region, thereby carrying out necessary detection. Liquid flowing is primarily carried out by capillary action. It can be applied to the detection apparatus herein or is arranged in a detection cavity to be in contact with the liquid sample or is used to detect whether the analytes in the liquid sample entering the detection cavity exist or not or the quantity thereof. The test element is generally arranged in the test cavity. When the test cavity has the fluid specimen, the fluid specimen is in contact with the test member for assay or detection.

The test strip or the lateral flow test strip itself are used to be in contact with the liquid specimen to test whether the liquid specimen contains the analytes. In some preferred implementation modes, the test element can further be arranged on some carriers. As shown in FIG. 13, for example, some carriers, the carriers are provided with one or more grooves where the test element is located. The carrier 900 can be formed by upper and lower plates. The test member is located between the two plates. The combined plate is provided with a window. A result in the detection region on the test member can be read with naked eyes or a machine via the window 901. In addition, a specimen dropwise adding hole 902 is used to dropwise add the specimen, for example, the liquid sample or the liquid or solid specimen processed by the liquid reagent. Certainly, optionally, it can further include a taking portion 903 for taking the test apparatus.

Analytes

An example capable of using the analytes in the present invention includes some small molecular substances, and the small molecular substances include drugs (for example drug abuse). “Drug abuse (DOA)” refers to use of drugs (generally playing a role of paralyzing the nerves) in a non-medical purpose. Abuse of the drugs will lead to physical and spiritual damage, thereby generating dependency, addiction and/or death. A case of drug abuse includes cocaine; amphetamine AMP (for example, black beauty, white amphetamine tablet, dextroamphetamine, dextroamphetamine tablet, Beans); methylamphetamine MET (crank, methamphetamine, crystal, speed); barbiturate BAR (for example, Valium, Reche Pharmaceuticals, Nutley, N.J.); a sedative (that is, a sleep assist drug); lysergic acid diethylamide (LDS); an inhibitor (downers, goofballs, barbs, blue devils, yellow jackets, methaqualone); a tricyclic antidepressant (TCA, i.e., imipramine, amitriptyline and doxepin); dimethoxymethylaniline MDMA; phencyclidine (PCP); tetrahydrocannabinol (THC, pot, dope, hash, weed and the like); an opiate (i.e., morphine MOP or, opium, cocaine (COC), heroin and hydroxydihydrocodeine); antianxietic and sedative-hypnotic drug, wherein the antianxietic is a drug primarily used for alleviating anxiety, tension and fear and stabilizing motion, and has sedative-hypnotic effects, including benzodiazepines (BZO), atypia BZ, fused dihydro NB23C, benzoazepines, ligands of BZ receptors, opened ring BZ, a diphenylmethane derivative, piperazine carboxylate, piperidine carboxylate, quinazolinone, thiazine and a thiazine derivative, other heterocycles, an imidazole sedative/painkiller (for example, hydroxydihydrocodeine OXY, adanon MTD), a propylene glycol deviative-mephenesin carbamate, an aliphatic compound, an anthracene derivative and the like. The detection apparatus using the present invention can be further used for detection of drugs in medical purpose with drug overdose, for example, a tricyclic antidepressant (imipramine or analogue) and acetaminophen and the like. The drugs absorbed by a human body will be metabolized to small molecular substances, and the small molecular substances exist in body fluids such as blood, urine, saliva and sweat or part of body fluids exist in the small molecular substances.

For example, the analytes for detection include but not limited to, creatinine, bilirubin, nitrite, proteins (nonspecific), hormone (for example, human chorionic gonadotropin, progesterone hormone, follicle-stimulating hormone and the like), blood, leucocyte, sugar, heavy metals or toxin, bacterial substances (protein or carbohydrate for specific bacterial, for example, Escherichia coli 0157: H7, staphylococcus, salmonella, fusobacterium, campylobacteria, L. monocytogenes, vibrio or Bacillus cereus) and substances related to biological features an urine specimen, for example, pH and specific gravity; any other clinic urine chemical analysis can be matched with the apparatus of the present invention to detect in a form of lateral flow detection. The analytes can further be some viruses, for example, any virus such as influenza viruses and novel coronaviruses or viruses of any other types or split virus fragments detected by the test strip clinically, for example, an antigen fragment and the like.

Sample Type

The sample of any type is tested by the apparatus of the present invention or is processed with the test tube rack of the present invention, including body fluids (for example, urine and other body fluids, as well as a clinic sample). The liquid sample can be originated from a solid state sample or a semi-solid state sample, including an excrement, a biological tissue and a food sample. The solid and semi-solid samples can be converted into liquid samples via any proper methods, for example, mixing, titrating, macerating, incubating, dissolving or performing enzymatic hydrolysis on the solid sample in a proper liquid (for example, water, a phosphate buffer or other buffers). The biological sample includes samples originated from living animals, plants and food and further includes urine, saliva, blood and blood components, a cerebrospinal fluid, a vaginal swab, a throat swab, a nasal cavity swab, a sperm, an excrement, sweat, an excretion, a tissue, an organ, a tumor, a culture of the tissue and the organ, a cell culture and a condition medium herein, regardless of human or animal. The food sample includes a food processed substance, a final product, meat, cheese, spirit, milk and drinking water. The plant sample includes samples originated from any plant, plant tissue, plant cell culture and condition medium herein. The environmental sample is the samples originated from environments (for example, a lake water sample or a sample from other water bodies, a sewage sample, a soil sample, an underwater sample, a seawater sample and a waste and waste water sample). Sewage and related waste can further be included in the environmental sample.

Flowing of Liquid

Flowing of liquid generally means that the liquid flows from one place to the other place. Under a common circumstance, most liquids in natural flow to a low place from a high place under the action of gravity. Flowing herein is dependent on an external force, that is, flowing under the action of gravity, and can become flowing under natural gravity. Besides gravity, flowing of liquid can further overcome gravity to flow from the low place to the high place. For example, due to extraction of the liquid or oppression of the liquid or stress of the liquid, the liquid flows to the high place from the low place, or the liquid flows by means of a relation of a pressure by overcoming the gravity of the liquid.

### Detailed Description

How to implement the present invention is described by the specific modes below. The implementation modes are specific modes enumerated definitely. Those of ordinary skill in the art can easily think additional specific modes in the mode, the specific additional implementation modes fall into the scope of the protection of the claims. The scope is reflected and defined specifically according to claims.

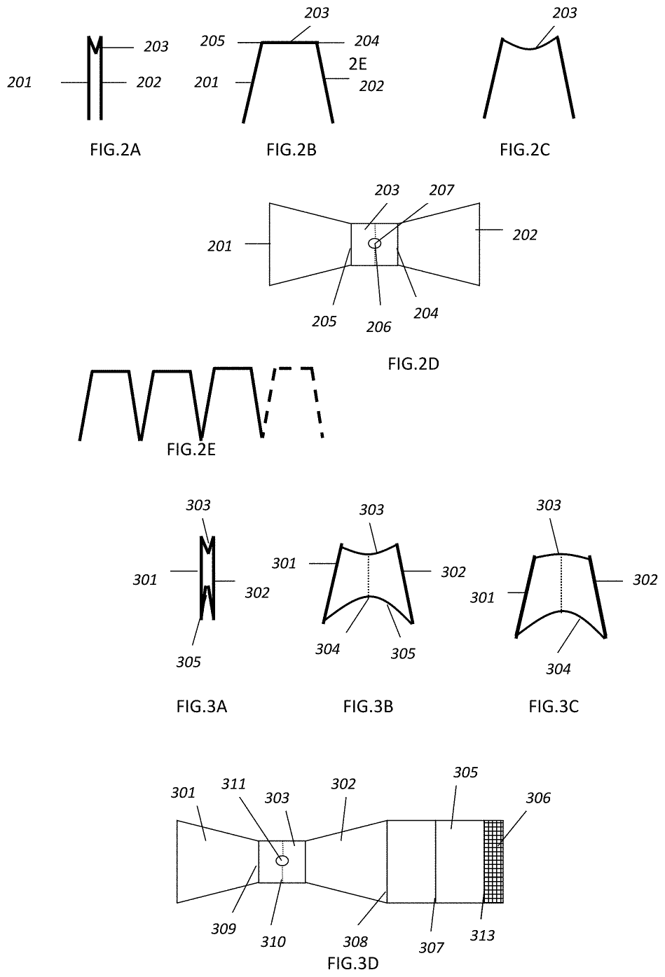

Referring to FIG. 2, a specific implementation mode of the present invention is described. In the mode, the test tub rack includes a first surface 203 and a first supporting surface 201 and a second supporting surface 202 that support the first surface. The first surface is provided with a hole which is a container for receiving or placing a tube body, for example, a test tube or a tube body with a solution, as shown in FIG. 13A.

It is actually a simple foldable test tube rack. The “test tube” herein is merely a common and easily understandable name and is not used to limit the rack body to place a test tube in general sense. The rack body can be used for placing any containers, for example, the test tube (as shown in FIG. 31A), a centrifuge tube or a container. The container can be container of any type, for example, a plastic, glass and a metal container. Solutions or solid reagents can be accommodated in the container in advance. In some examples, a container like a tip tube and a PCR tube can be inserted into the hole in the rack body and is filled with a solution for treating the sample, for example, a lysate or any other liquid. The liquids contain certain chemical reagents and the chemical reagents can treat the sample. For example, the solution contains the reagent of a lytic virus, when the sample contains the virus, the virus is split to a fragment which is generally an antigen fragment. The antigen fragments can be detected by subsequent steps, for example, an immune method. In some modes, the test tube is filled with the liquid reagent, and the test tube is sealed. When it is needed to treat the sample, a sealing film is torn off. For example, when an aluminum foil is used to seal, the aluminum foil is torn off to make contact of the specimen and the liquid reagent. The specimen can be any specimen, for example, a throat swab collected by cotton. When the specimen in an oral cavity or in a nasal cavity is removed, the cotton swab is directly inserted into the tube body to be in contact with the liquid reagent, so that the liquid reagent treats the sample, for example, split virus or bacteria or the analytes therein. After treatment, subsequent detection or assay can be carried out with the liquid reagent (it may contains the analytes at the moment). For example, after sample treatment is finished, the cotton swab is left in the test tube, a dropper is installed, the test tube is taken down, the test tube is reversed, and the test tube is squeezed by a finger, so that liquid drops are dropped out for detection. Generally, the dropped liquid can be dropped to the test element, for example, a specimen applying region on the test member.

Therefore, the first surface 203 is provided with a hole 207 (there may be one or more dependent areas), and the hole 207 is used to insert or place the container, for example, the container like the test tube. A connection between the first surface and the supporting surface is provided with the broken lines 204 and 205, and the broken lines herein are not manually arranged. The first surface and the supporting surface are folded to form an interface or a boundary line, so as to distinguish the two surfaces. In an initial state, the first supporting surface 201 and the second supporting surface 202 and the first surface 203 may be planar paper or paperboards, and the paperboards are mechanically cut and are perforated in the first surface 203. The size of the hole is equivalent to that of the tube body for placement. When it is needed to use, the fold lines 204 and 205 are folded downwards to form a “n” shape, so that the rack body is in a standing form (FIG. 2B). At the moment, the test tube filled with the solution is inserted into the hole 207, so that the test tube is kept in a vertical state, and therefore, it is convenient to operate, for example, treat the sample. It is in particular convenient in family detection and is quite easy to operate. Meanwhile, the small accessories are disposable, and can be abandoned randomly after detection. When the rack body is made from a paper material, it is quite to process, so that the environmental damage is reduced. On the other hand, as far as manufactures or retailers that provide detection reagents are concerned, a conventional plastic bracket is not needed. Before use, the rack body is merely a paper sheet, and the package of the rack body does not occupy a huge space. The rack body is quite light, so that a lot of cost is saved. However, it is needed to open a die to manufacture the plastic bracket and the plastic product will lead to environmental pollution, and it is hard to treat. For example, the form can be in a form of FIG. 2D: a form of a paperboard having a mark with a crease line. An operator folds the paperboard according to the crease line according to an operation description of the operating description, for example, folds downwards according to the crease lines 205 and 206. The first supporting surface 201 and the second supporting surface 202 are folded to form a pattern of FIG. 2B. Thus, the rack body can be placed on an operating surface to operate. In some embodiments, if the first surface is provided with the fold line 206, the first surface is not necessarily a plane when being folded but can be a curved surface, for example, a pattern of FIG. 2C, and the curved surface is further provided with the hole 207 where the test tube is inserted. Certainly, the curved surface herein can either be bended downwards or bended upwards, for example, a curved surface, the bending surface of which is opposite to that of the first surface shown in FIG. 2C. Certainly, it can further be a mode similar to FIG. 2E. Continuously folded, a plurality of continuous single bodies such as FIG. 2A or FIG. 2B are arranged. Each of the single bodies is folded and shrunk according to a mode in FIG. 2A and is unfolded according to a mode in FIG. 2E when being unfolded.

In some modes, it is not a planar paperboard but exists in form of being folded and shrunk (for example, as shown in FIG. 2A). If necessary, the shrunk tube rack is in an opened state. For example, when it is not opened, the fold lines 204 and 205 and the fold line 206 are folded and shrunk together (for example, as shown in FIG. 2A). If necessary, the supporting surfaces 202 and 201 are opened, so that the rack body is distracted and is placed on the operating surface, for example, a test board or a desk top of a family, and operation of self detection can be carried out. At the time, the first surface 203 supported by the supporting surface is certain distance from the operating surface. The test tube can be inserted into the hole 207 and is in a standing gesture. The position of the tube body close to an orifice is located above the hole 207. The bottom of the tube can depend on the operating surface directly. Certainly, in order to fold the rack more compactly, the fold line 206 is further arranged on the first surface. When it is folded, it is folded by the fold line 206, so that it is more compact to fold and is small. When packaged with the detection reagent, it does not occupy the packaging space, so that it is convenient to manufacture and product, and the cost is saved.

During manufacturing, for example, as shown in FIG. 2D, paper of a certain thickness is used. The paper is cut by a machine to form the first supporting surface 201 and the second supporting surface 202 as well as the first surface 203. The first surface is provided with a hole 207, and meanwhile, the fold lines 111 and 112 are arranged between the first supporting surface and the second straight surface and the first surface. The method for forming the fold lines forms the shrunk lines 111 and 112 in the position of the fold line by stamping the fold lines by the machine. The lines may not exist but when it is needed to fold, the fold lines 111 and 112 can be folded together and can be kept shrunk. When it is placed on the operating surface, it may erect on the operating surface by means of support of the supporting surface. For further example, the positions of the fold lines are punched continuously, the holes are at intervals, for example, 1 mm or 2 mm, and therefore, an easily folded form can be realized. Those of ordinary skill easily understand that other folding modes can be used as a folding mode in the present invention. In the implementation mode, the base surface, the splicing surface and the steady surface described below are not included. In the following modes, when it has the base surface, the splicing surface and the steady surface, the fold lines of the paperboard and the specific size of the paper board are pressed by stamping the paperboard.

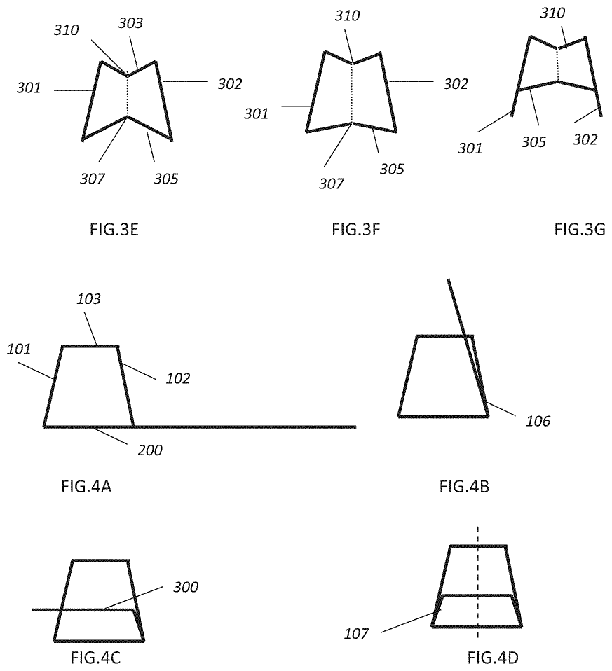

In some embodiments, in order to make the rack body more stable, the rack body is further provided with the base surface 305, the base surface is connected with the fold line 308 of the second supporting surface 302 and the base surface 305 can further be connected with the first supporting surface. When it is in the folded and shrunk state, the first surface 303 and the base surface are folded inwards, so that it is in the shrunk state (FIG. 3A). The base surface is connected with the supporting surface via the fold line. When it is opened, the base surface can further be in a curved surface form. The first surface 303 is a curved surface, too. The highest point 304 of the curved surface of the base surface and a center of the hole 311 of the first surface 303 are located in a same linear position. Certainly, it is feasible if they are not in a straight line. For example, as shown in FIG. 3B, when the tube body is inserted into the hole 311, the bottom of the tube is dragged by the highest point of the base surface. In addition, when the base surface is the curved surface, the whole supporting rack is more stable as a result of a tensile force between the base surface and the supporting surface by contacting the two supporting surfaces or the supporting legs 314 and 315 of the operating surface. According to an arch bridge principle, the arch bridge can bear a heavier load. The base surface is similar to the arch bridge and the whole gravity is dispersed on two legs. When it is manufactured by using some paperboards which are not very thick, it still can bear the weight of the tube body.

Generally speaking, when the folded and shrunk bracket is in the opened state, in the presence of the crease, the first surface 303 and the base surface 305 may not be standard curved surfaces or V-shaped form, for example, as shown in FIG. 3E and FIG. 3F. In the presence of the fold line, the first surface 303 and the base surface 305 are still in the folded state when being opened, merely with the angle problem. Certainly, when the tube body is inserted, the first surface can further be in a linear state or the formed included angle is increased or is nearly a plane. Similarly, there is still oppression at the bottom of the tube body to the base surface or a force given by an operator to inert the tube body, so that the included angle of the base surface is increased or is nearly in a form of a straight surface.

In some modes, in order to connect the base surface 305 and the first supporting surface together, the base surface is provided with the pasting surface 306. When it is manufactured, the pasting surface is pasted to the inner surface of the first supporting surface 301 together, so that the base surface and the first supporting surface are connected, and the base surface 305 and the pasting surface 306 are connected via the fold line or the fold line 313.

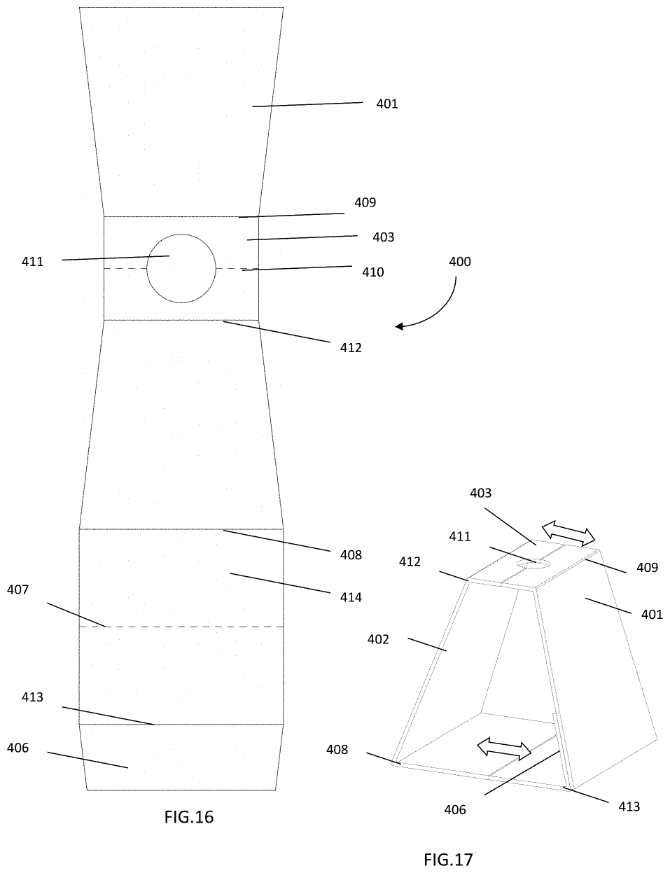

For example, as shown in FIG. 16 to FIG. 17, another implementation mode is provided. The first surface 403 is provided with an insertion hole 411 of the tube body, the first surface 403 is provided with the crease line 410 and the first supporting surface 401 and the second supporting surface 402 connected with the first surface, and the two surfaces are connected via the fold lines 409 and 412. It is still the base surface 414 connected with the second supporting surface 402 and the pasting surface 406 connected with the base surface, and the surfaces are connected via the crease line or a crease portion or the fold lines 408 and 413. When it is assembled to a product, it is folded according to the fold lines so as to form the final product as shown in FIG. 17, FIG. 19 and FIG. 20. As spliced by the splicing layer, the packaging form is only a folded mode. Thus, when it is operated, it in a folding and shrinking mode is opened to form the bracket. In order to fold conveniently, the base surface is further provided with a fold line 407 and the fold line is generally arranged at a full bisector or a substantial bisector of the base surface and is kept consistent with the position of the fold line 410 of the first surface 403. It can further be the bisector of the first surface. After being folded, as shown in FIG. 20, the first surface 403 is folded inwards by the fold line. The base surface 414 is folded inwards by the fold line. The two supporting surfaces are folded by the fold lines 410 and 4071, thereby forming the shrunk form. When it is needed to open, the supporting surfaces 401 and 402 are opened manually, so that the first surface 403 and the base surface 414 are unfolded to form a shape similar to a isosceles trapezoid, so that the rack body is in a standing state. Certainly, when the rack body is used completely, it can further be shrunk and folded.

FIG. 20 shows the shrunk and folded state. When it is in the shrunk state, the fold lines are at the minimum angles or the surfaces on two sides of the fold lines lean against each other nearly or the distance is minimum. When it is in the folded and shrunk state for a long time and it is needed to open in a natural state, the two surfaces divided by the crease have naturally stretching forces, for example, two surfaces of the first surface separated by the crease 410 and the supporting surface and the first surface connected by the fold lines 409 and 412 further have the naturally stretching forces. Similarly, the two surfaces of the base surface separated by the crease line further have stretching abilities, and the creased formed by the fold lines 408 and 413 connecting the base surface and the supporting surface further has the similar stretching ability. Thus, when it stretches naturally, the stretched bracket is formed in the state shown in FIG. 20. As mentioned above, for example, as described in FIG. 3E and FIG. 3F, the first surface and the base surface are not substantially planes but form an included angle. Certainly, the planar structure as shown in FIG. 17 may be further formed, i.e., the first surface and the base surface are in planar forms.

If it is to form the state shown in FIG. 17, the operator can neaten the supporting surface or the first surface and the base manually, so that it is in the planar state. At the time, the length of the base surface generally refers to a distance between the edges of the two supporting surfaces when it is opened. At the time, the base surface is located between the edges of the supporting surfaces (the fold line 408 of the base surface and the second supporting surface and the edge 413 of the first supporting surface). When the surfaces have relative thicknesses, for example, papersheet structures 1 mm t 2 mm thick, the base surface can fix the distance between the edges of the first supporting surface and the second supporting surface, so that the rack body stands without collapse or topple, and thus, when the test tube is inserted into the hole 411, it is easy to stabilize. The base aims to keep the distance between the supporting surfaces and increase the contact area of the operating surface, and the rack body is more stable. In a manufacturing mode, it can be further formed by a thin paper sheet by different fold lines, or can be packaged in form of papersheet or packaged by way of folding. It is to be understood that if no extra finish is carried out, the natural state may be the state shown in FIG. 19. In the above two states from being folded and shrunk to naturally stretched and manually finished by the operator, the tube body can be inserted to support the test tube for treating the samples or carrying out some other operations.

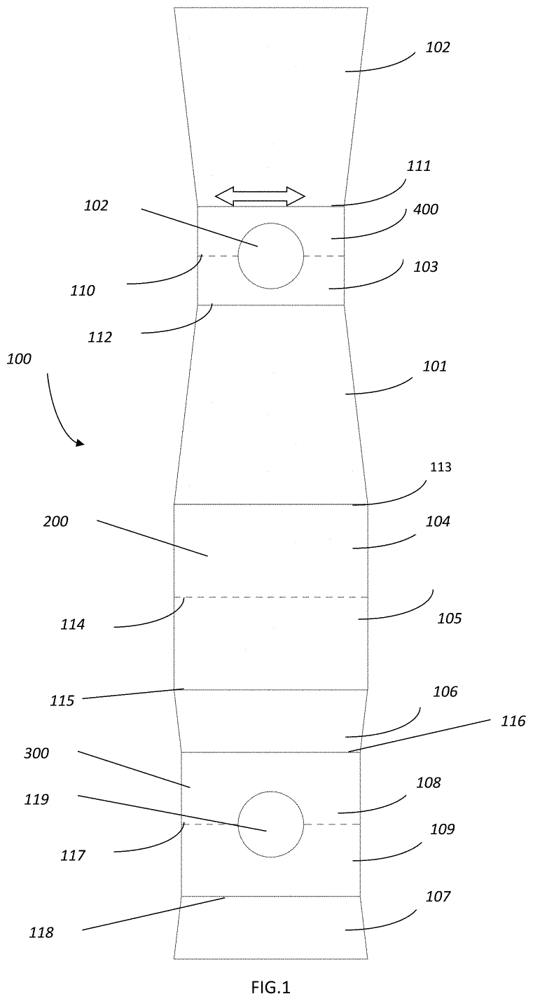

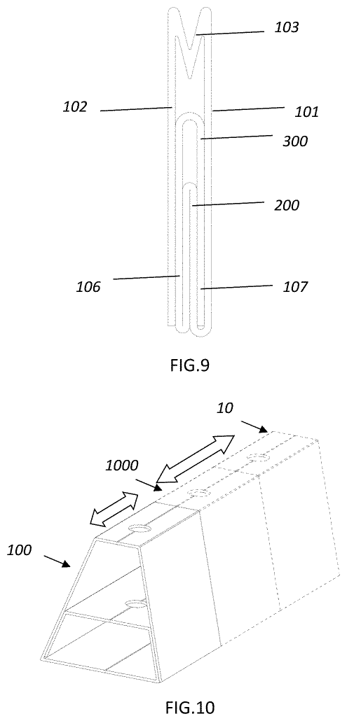

As shown in FIG. 1, FIG. 5 to FIG. 9, in some modes, besides the first surface and the supporting surface, the test rack further includes the steady surface. The steady surface 300 is arranged between the first supporting surface 101 and the second supporting surface 102 and is located between the first surface 103 and the base surface 200 as well. Certainly, it can be imaged that it is feasible without the base surface. It is further feasible to arrange the steady surface between the two supporting surfaces. The steady surface 300 can be arranged in any position of the two supporting surfaces. In some modes, it is arranged in a position in the middle or close to the first surface 103 or a position close to the supporting surface away from the operating surface. The steady surface is arranged to increase the stability of the bracket, and meanwhile, the bearing capacity is further increased. In a preferred mode, the steady surface 300 is connected with the first splicing surface 106 via the fold line 116. It is to be understood that in the preferred mode, the fold line 117 is arranged on the steady surface. Certainly, the fold line 117 can be arranged in a position dividing the steady surface 300 equally. When it is folded, the steady surface is folded and shrunk via the fold line 117. As shown in FIG. 9, when it is opened, it is unfolded to form the rack body. The unfolded state is the state by natural stretching or manual unfolding. For example, FIG. 8 shows the state of natural stretching. In some modes, the steady surface can further be provided with a hole 119, and the hole 119 and a hole 120 in the first surface 103 receive the tube body together. Therefore, the position of the tube body on the test tube rack does not swing due to limitation of the two holes 119 and 120 up and down.

Thus, when it is folded and shrunk, the steady surface 200, the base surface 300 or the first surface 103 can be folded toward a same direction, for example, folded upwards or downwards or the first surface 103 and the base surface 200 are folded inwards (in the implementation mode with the base), and the steady surface can be folded upwards or downwards. In a word, it can be in the folded and shrunk mode. The direction in which each surface is folded is not defined.

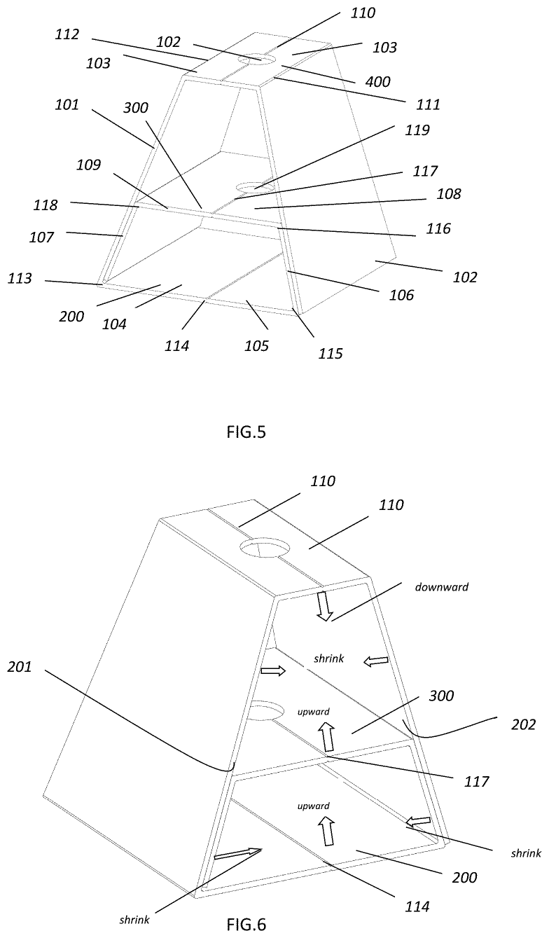

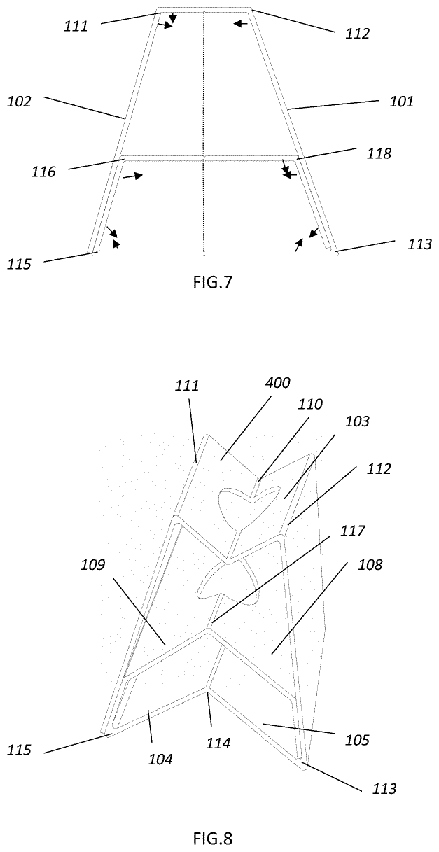

According to the folding direction shown in FIG. 6, the first surface is folded downwards. Along the fold line 110, the steady surface can be folded downwards or upwards along the fold line 117, the base surface is folded upwards along the fold line 114, the folding process drives the supporting surface to close and shrink, and the closing and shrinking process is completed by the crease lines connecting the surfaces. The creases play a role of hinges similarly. An arrow head in FIG. 7 can be deemed as a direction through which each surface is shrunk inwards via the crease so as to form the shrunk state after being folded (FIG. 9).

In another preferred mode, the second splicing surface 107 connected with the steady surface 300 is connected with the inner surface 201 of the first supporting surface via the second splicing surface. The steady surface 300 is connected with the second splicing surface 107 via the fold line 118 (FIGS. 2A-2E show an integral rack body structure). Therefore, by splicing the two splicing surfaces and connecting the fold lines of the surfaces, the structure of the integral test tube rack is formed. The structure can be folded and shrunk and can further be unfolded to form the rack body structure. The structure is placed on the operating surface to insert the test tube or the container for the convenience of sampling and treating the samples by using the solution in the test tube.

In the specific manufacturing process, it is easy to manufacture. The integral manufacturing process of the rack body structure shown in FIGS. 2A-2E is introduced in detail by the integral paperboard. First, a paperboard with a certain thickness is selected, for example, the paperboard 1 mm or 2 mm thick, a shape shown in FIG. 1 is formed by stamping, and the paperboard shape is divided into several function areas. The supporting surface is divided into the first supporting surface 102 and the second supporting surface 101, the two supporting surfaces are connected with the first surface 103 respectively, and the first surface is provided with the hole 120 to insert the tube body container. The first supporting surface 102 herein is a single surface, the base surface 200 is further connected with the second supporting surface, the middle of the base surface 200 is further provided with the fold line or the fold line 114, the fold line divides the base surface into two portions 104 and 105, and the two portions 104 and 105 are divided via the crease line. Similarly, the first surface 103 is further provided with the fold line 110 and is divided into two portions 103 and 400. The two portions 103 and 400 are connected together via the fold line 110. It is the first splicing surface 106 connected with the base surface, and the first splicing surface is connected with the inner surface 202 of the first supporting surface. Then it is the steady surface 300 connected with the first splicing surface 106. Similarly, the steady surface is further provided with the fold line 117. The fold line divides the steady surface into two portions 109 and 108. The two portions 109 and 108 are connected together via the fold line 117. The steady surface is further provided with the hole 119, and the hole 119 in the steady surface 300 and the hole 120 in the first surface are used for fixing the tube body. It is the second splicing surface 107 connected with the base surface, and the splicing surface 107 is connected with the inner surface 201 of the second supporting surface 101 together. The first surface, the supporting surfaces, the base surface, the splicing surfaces and the steady surface are divided via the crease lines. When the rack body is manufactured, the crease lines are folded, so that the rack body structure as shown in FIGS. 2A-2E is formed. When the rack body structure shrinks, it is in the shrunk state as shown in FIG. 9. The first supporting surface and the second supporting surface are trapezoidal. The first surface 103 is cuboid-shaped and the long edge of the cuboid is defined by the fold lines 111 and 112. The edge 203 of the first supporting surface 102 and the edge 113 of the second supporting surface 101 are longer than the fold lines 111 and 112. Thus, when it is unfolded, the tube body rack can stand on the operating surface. Certainly, not all the surfaces are cuboid or trapezoidal. The surfaces can be in any other shape as long as it supports all the surfaces and is composed of surfaces with holes through which the tube bodies can be inserted. For example, the supporting surfaces can be cuboid, the first surface can be cubic, and the shape of the steady surface or the base surface is not required specifically, and can be a combination of any shapes of cuboid, cube, triangle, trapezoid and the like. The lengths of the supporting surfaces can be designed randomly. It is designed randomly according to the length needed to be inserted into the tube body, for example, 3-20 cm. In some implementation modes, the steady surface 300 is arranged close to the base surface 200, so that the gravity of the base surface is increased and moves downwards, and therefore, the stability of the rack body can be further improved. It is commonly arranged close to the base surface and is located in a position at ⅓ of the height of the supporting surface, calculated upwards from the base surface.

Introduction of the process of forming the rack body by folding in FIG. 1 is made below. First, the two supporting surfaces and the first surface form a skeleton structure by folding the supporting surfaces 101 and 102 and the fold lines 112 and 111 of the first surface 103, as shown in FIG. 4A. Then, the base surface 200 is folded downwards by the fold line 113 to form the base surface 105, then the base surface is substantially parallel to the first surface 103, and then the fold lines 115 and 116 are folded, so that the first splicing surface 106 is in contact with the inner surface 202 of the first supporting surface 102 and is bonded together. The steady surface 300 is folded downwards via the fold line 116, so that the steady surface is located between the first surface 103 and the base surface 200. Then the fold line 118 is folded downwards, so that the splicing surface 107 is bonded to the inner surface 201 of the second supporting surface 101 together. Thus, the rack body structure as shown in FIGS. 2A-2E is formed. Common simple manufacturing methods and folding modes are merely introduced herein. There are still other imaginable manufacturing methods falling in expansions or improvements under quintessence of the present invention. The folding directions are not merely the unique directions of the examples. The folding mode can be either a manual folding mode or a machine automatic mode. In addition, spliced by the splicing layer, it can be either a paperboard with a glue coating layer or splicing formed by heat processing and a laser welding mode. A preferred mode is that a layer of glue is coated to the surfaces of the splicing surface 106 and the second splicing surface 107. During manufacturing, the first splicing surface 106 and the second splicing surface 107 are bonded to the inner surface of the supporting surface together by means of hot compressing or a mechanical pressure.

It is to be understood that the rack body structure as shown in FIGS. 2A-2E is merely a specific embodiment of the present invention. As mentioned above, it can be short of the base surface, the splicing surface and the steady surface, the two supporting surfaces, the first surface and the holes therein are merely reserved, thereby forming a simple tube body rack structure which can be shrunk and unfolded. Certainly, it has the base surface or the splicing surface or the steady surface, and one of objectives is to increase the supporting capacity and the stability of the rack body.

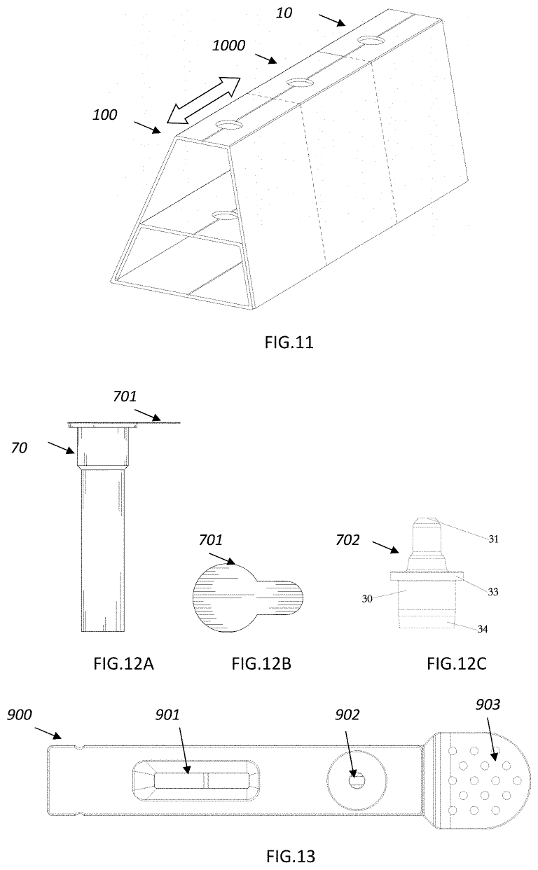

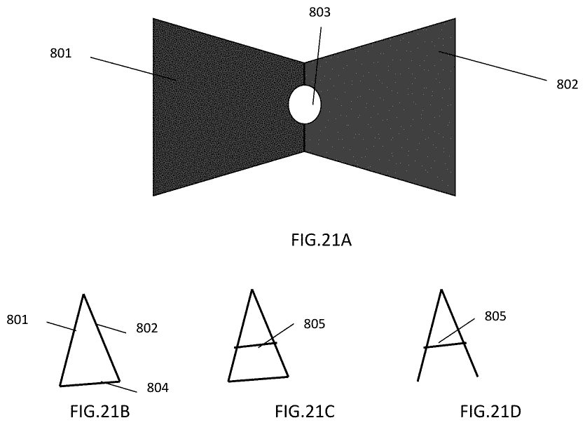

In some other modes, under the circumstance of no first surface, the merely two supporting surfaces can realize the test tube rack in two states: folded and shrunk and opened states. For example, as shown in FIG. 21, the two supporting surfaces 801 and 802 are folded, and the insertion holes 803 are formed in two sides of the crease line. If the paper which is thicker or harder is used, it can stand on the operating surface. For example, the test tube as shown in FIG. 12A can be inserted into the hole and is in a standing gesture. The positions of the first and second supporting surfaces (positions of dotted lines in FIG. 22) are respectively provided with semi-circular notches, and the two semi-circular notches are combined to form one hole through which the test tube can be inserted. In the implementation mode, without the first surface, the notches formed in the supporting surface are combined to form the hole for inserting the test tube. Certainly, in the mode, the base surface 804 can be arranged to connect the two supporting surfaces (FIG. 21B), the steady surface 805 can be arranged to connect the two supporting surfaces (FIG. 21D) or the supporting surface is provided with the base surface and the steady surface as shown in FIG. 21C. Certainly, according to the abovementioned manufacturing method, it can be manufactured with reference to the method introduced in FIG. 1 or FIG. 16 without the first surface.

The “crease line”, the “fold line” and the broken line” herein express interchangeablity rather than lines drawn herein. They represent positions. In the positions, the two surfaces can be folded oppositely or doubled back or bended, or the surfaces are hinged, and the two surfaces folded by a hinge or the relative positions are changed. The rack body structure can be manufactured by any sheet: a material with certain rigidity, for example, a thin plastic sheet, a metal sheet and a paperboard. A preferred scheme is the paperboard. The paperboard is usually 1 mm or 2 mm thick or is thicker. In addition, the paperboard can be coated with a film. Preferably, the material has a thickness and the hard paperboard is used to manufacture the rack. The crease line, the fold line and the broken line can be formed by either a machine punching mode or continuous interval punching mode in the fold line position. Known methods capable of manufacturing the rack in positions needed to fold are easily implemented. Folding herein can further be such that when it is folded, the test tube rack can be folded along the crease from a paperboard or is in a form of the three-dimensional tube rack via the crease. When it is in the form of the three-dimensional tube rack, the test tube rack can be in two states: folded and shrunk state and stretching state. Stretching further includes natural stretching and manual stretching or stretching combining natural stretching and manual stretching. The so called natural stretching herein means that after the crease, when it is in the natural state, there is an internal force for natural stretching. The so called manual stretching means that the tube rack folded and shrunk by means of an external force is stretched to the three-dimensional form. The shrunk form exists in form of external force compression, for example, FIG. 2A, FIG. 3A, FIG. 9, FIGS. 21A-21D and the like.

The above merely introduces the rack body structure with a single hole. When a plurality of holes are needed, a plurality of different tube bodies are expected to be inserted, which can be implemented by the present invention. The test tube rack can be in two states: folded and shrunk state and stretching state.

In some modes, the width of the paperboard manufactured can be amplified in multiple times, for example, transverse amplification (actually longitudinal expansion), for example, 1 time, 2 times, 3 times, 4 times, 5 times or 10 times, for example, the edge 203 of the first supporting surface is amplified to 2-10 times in proportion (longitudinal extension), the first surface 103 is in proportion. The first surface 103 extends longitudinally. Thus, 2-10 or more holes (arrow head shown in FIG. 1, and arrow head direction shown in FIG. 10) are formed longitudinally in the first surface. Correspondingly, if there is no base surface or steady surface, it extends longitudinally, too, and in this way, a plurality of tube body structures can be placed. As shown in FIG. 2B, FIG. 2C, FIG. 3B, FIG. 3E, FIG. 22 and the like, it can extend longitudinally, and a plurality of holes can be formed, so that the plurality of tube bodies can be inserted or inserted into the holes.

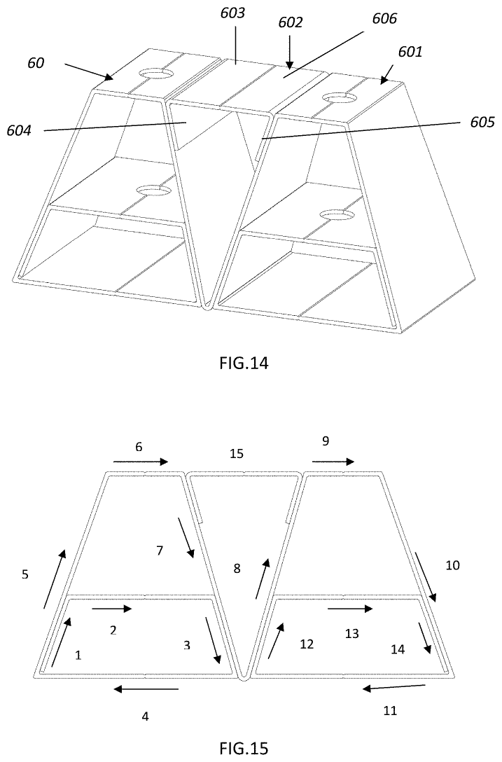

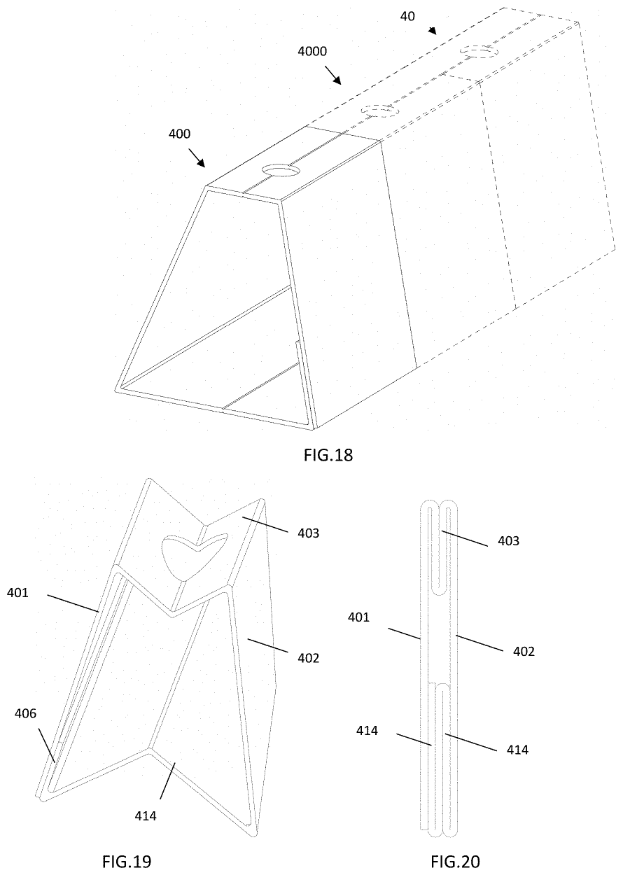

In another mode, as shown in FIG. 14 to FIG. 16, it can expand transversely. For example, as shown in FIG. 15, it has two single bodies. The two single bodies are primarily formed by one paperboard. It is folded along the set fold line according to the direction shown by the arrow head shown in FIG. 15. It can become two foldable test tube racks capable of inserting tube bodies at one time from sequence numbers 1-14. Each sequence number represents one surface, and the surfaces represented by the next and previous sequence numbers are formed by being folded. The two surfaces can be folded, shrunk and unfolded according to the abovementioned method. Meanwhile, in order to ensure stable connection of the two single bodies, a connecting surface is arranged between the two single bodies. One end of the connecting surface is connected with the first single body and the other end thereof is connected with the other single body, and the connecting surface 602 and the supporting surface are bonded and connected. The connecting surface is further provided with the fold line or the crease so as to be divided into two surfaces 606 and 603. The way of connecting the connecting surface and the two single bodies can be as follows: the connecting surface 602 has two splicing surfaces 604 and 605 which are respectively bonded to the supporting surfaces of the two single bodies 60 and 601. Thus, it is ensured that after the two single bodies are folded, when it is unfolded freely, each single body is kept at a proper distance. It can be imaged that in this form, the other two single bodies can be connected by the connecting surface, thereby increasing in a multiple of 2. It is an expandable mode. In some other modes, the foldable test tube shown in FIG. 18 or FIGS. 3A-3G can be expanded and increased according the above mode. The foldable test tube rack shown in FIGS. 2A-2E can be increased transversely, for example, transversely expanded by way shown in FIG. 2E.

In some modes, there is still another transverse expanding mode which expands the transverse length of the first surface. For example, as shown in FIG. 17, the transverse width of the first surface is expanded, so that the area of the first surface is expanded. The expanding mode can be expansion in an equal proportion, and the size of the supporting surface cannot be changed. If it is provided with the base surface, the base surface extends transversely. If it is provided with the steady surface, the steady surface extends transversely, too (the arrow head direction shown in FIG. 17 is transverse expansion). One or more rows of holes for inserting the test tubes are formed in the first surface. In some modes, in order to make the test tube rack with multiple rows of holes be foldable, one or more fold lines or creases are arranged on the first surface, and the first surface is folded and shrunk along the fold lines or creases. If it is provided with the base surface of the steady surface, one or more fold lines or creases are arranged in a way same with the first surface or in a same position of the first surface, so that the base surface or the steady surface is folded in the transverse direction while the first surface is folded. Therefore, the test tube with the plurality of insertion holes is folded and shrunk.

Actually, the area of the first surface extends in two directions: longitudinal and transverse directions, and the plurality of holes can be formed in the first surface, and the plurality of test tubes can be inserted into the holes, so that different viruses are detected.

Detection Apparatus

The detection apparatus refers to an apparatus for detecting whether the specimen contains the analytes or not. The detection apparatus herein can purely include a detection cavity and test elements arranged inside, and it can be called the detection apparatus herein. For example, the detection apparatus includes the detection cavity, and the detection cavity includes the test element or test element comprising a carrier. In some modes, the detection cavity is provided with a liquid inlet, and a liquid specimen flows into the detection cavity through the liquid inlet and is in contact with the test element. In some modes, the specimen applying region of the test element is close to the liquid inlet. Thus, the liquid flows into the detection cavity from the inlet to be contacted with the specimen applying region, so that the liquid specimen flows to the detection region along the specimen applying region, and therefore, the analytes are assayed and detected.

In some modes, the detection apparatus is similar to a detection plate. An independent test element can further be used as an implementation mode of the present invention. FIG. 13 shows the detection apparatus in an embodiment, including a window for applying a liquid and a window for reading a test result. Operation is described below by using an embodiment.

For example, as shown in FIG. 18, combined with FIG. 13, the test apparatus is taken from a packaging box with the detection apparatus, for example, the detection apparatus as shown in FIG. 14. Then, the foldable bracket is taken out. The bracket is pre-folded and packaged. The packaging form can be a form as shown in FIGS. 21A-21D and is in a folded and shrunk form, and can further be a form as shown in FIG. 20 and is in a semi-compressed and semi-shrunk form. The test tube or a sampling cotton swab or other sampler matched with the test tube is taken out from the packaging box. The test tube rack is placed on the operating surface. At home, it can be placed on a table top and in a lab, it can be placed on the test table. It can be placed on any plane outdoors. The test tube rack is in a standing gesture. The test tube 70 is inserted into the hole 411. A solution for treating a specimen is sealed in the test tube. The solution includes some reagents which can treat the specimen. Treatment herein can be dilution, elution or splitting of the analytes, for example, splitting virus particles to fragments and the like. As the test tube is sealed, the sealing sheet 701 can be torn off (FIG. 13B), then the test tube 701 is inserted into the hole 411, and then sampling is made, for example, coronavirus disease is detected, sampling in a nasal cavity or an oral cavity can be made with the cotton swab, and then the cotton swab is inserted into the treatment solution of the test tube to wait for treatment. After the treatment, the cotton swab is broken and is left in the test tube or is taken away. A dropper 702 (FIG. 13C) is mounted on the test tube, one ends 34, 30 of the dropper is inserted into the orifice and the other end 31 is exposed, and the depth of the dropper inserted into the orifice is defined by means of the protruding flange 33. Then the test tube with the dropper is taken away from the test tube rack, and liquid drops are dropwise added into the window of the detection apparatus that applies the liquid via the dropper, so that whole detection is finished. After detection, the paper test tube rack is shrunk and stored again, or is abandoned directly, or is packaged by using a special bag and is treated by a special environmental protection mechanism. The folded test tube rack is made from a paper material generally, and is easily degraded. In addition, as the package can be folded, the packaging space is reduced and the manufacturing cost is lower.

All patents and publications mentioned in the description of the present invention represent disclosed technologies in the field, which can be used in the present invention. All the patents and publications cited herein are listed in references like each publication is cited independently specifically. The present invention herein can be realized under the condition of being short of any one or more elements and one or more limitations, which is not specified herein. For example, terms in each example herein “include”, “substantially composed of” and “composed of” can be replaced by other two terms among the two. The so called “one” herein merely represents meaning of “one” rather than excluding merely one, and it further can represent more than two. The used terms and expressions herein are description modes rather than being limited. It is not intended to indicate that the terms and explanations herein exclude any equivalent features. It is to be known that any proper changes or modifications can be made within the scope of the present invention and claims. It is to be understood that the examples described in the present invention are some preferred examples and features. Those skilled in the art can make some alterations and changes according to quintessence described in the present invention. These alternations and changes also fall within the scope of the present invention and the scope defined by the independent claims and attached claims.

1. A test tube rack, the test tube rack comprising:
a first supporting surface;
a second supporting surface;
a first hole used for inserting a test tube;
wherein the first supporting surface and the second supporting surface can be folded.

2. The test tube rack according to claim 1, wherein the test tube rack further comprises a first surface, the first surface is connected with the first supporting surface and the second supporting surface, the first surface comprises the first hole for inserting the test tube, and the connection comprises a connection via a broken line or a crease; or the first surface is connected with the first supporting surface and the second supporting surface respectively via the broken line and the crease, and the first surface comprises the hole.

3. The test tube rack according to claim 2, wherein one end of the first supporting surface is connected with one end of the first surface via the broken line or the crease, and one end of the second supporting surface is connected with the other end of the first surface via the broken line or the crease.

4. The test tube rack according to claim 3, wherein the test tube rack further comprises a base surface, one end of the base surface is connected with the other end of the first surface via the broken line or the crease, and the other end of the base surface is connected with the other end of the second surface via the broken line or the crease.

5. The test tube rack according to claim 4, wherein the first supporting surface and the second supporting surface are in trapezoidal shapes, square shapes or rectangular shapes; or the first surface is in a trapezoidal shape, a square shape or a rectangular shape.

6. The test tube rack according to claim 5, wherein the first supporting surface and the second supporting surface are in trapezoidal shapes, and wherein an area of the first surface is smaller than that of the base surface; or a width of the first surface is equal to that of the base surface; or a length of the first surface is smaller than that of the base surface.

7. The test tube rack according to claim 6, wherein the width of the first base surface is equal to or substantially equal to that of the first surface.

8. The test tube rack according to claim 7, wherein the test tube rack further comprises a steady surface, one end of the steady surface being connected with the first supporting surface and the other end thereof being connected with the second supporting surface.

9. The test tube rack according to claim 2, wherein the test tube rack further comprises the steady surface, one end of the steady surface being connected with the first supporting surface and the other end thereof being connected with the second supporting surface, and the steady surface being located below the first surface.

10. The test tube rack according to claim 9, wherein the steady surface comprises a second hole used for inserting the test tube, and the first hole and the second hole are arranged in a vertical direction.

11. The test tube rack according to claim 10, wherein two ends of the steady surface are further connected with a first paste surface and a second paste surface, the first paste surface is bonded to the first supporting surface, and the second paste surface is bonded to the second supporting surface.

12. The test tube rack according to claim 11, wherein the steady surface is located between the first surface and the base surface.

13. The test tube rack according to claim 11, wherein two surfaces of the first surface, the first supporting surface, the second supporting surface, the steady surface, the first paste surface or the second paste surface of the test tube rack are connected via the broken line or the crease, or two surfaces of the first surface, the first supporting surface, the second supporting surface, the steady surface, the first paste surface or the second paste surface of the test tube rack can be folded via the connected broken line or crease.

14. The test tube rack according to claim 12, wherein the first surface, the first supporting surface, the second supporting surface, the steady surface, the first paste surface or the second paste surface of the test tube rack are formed by folding a planar paperboard.

15. The test tube rack according to claim 13, wherein the test tube rack has two states: a folded and shrunk state and an opened state.

16. The test tube rack according to claim 4, wherein the base surface and the first surface further comprise the broken line or the crease, and the base surface and the first surface can be folded via the broken line or the crease.

17. The test tube rack according to claim 2, wherein the first surface extends longitudinally or transversely, so that the first surface is provided with a plurality of first holes used for inserting the test tubes.

18. A test tube rack, comprising:
a first surface comprising a first end and a second end, the first surface being provided with one or more holes used for inserting test tubes;
a first supporting surface and a second supporting surface, one ends of the first supporting surface and the second supporting surface being respectively connected with the first end and the second end of the first surface, and the connection being a connection via a crease or a broken line; and
a base surface, the base surface being connected with the first supporting surface and the second supporting surface, wherein the base is located below the first surface.

19. The test tube rack according to claim 16, wherein the base surface is connected with the first surface and the second supporting surface via the crease or the broken line.

20. A test tube rack, comprising:
a planar paperboard, the paperboard being divided into a first surface, a base surface, a first supporting surface, a second supporting surface, a steady surface, a first paste surface and a second paste surface by a crease or a broken line, wherein the first surface comprises a first end and a second end, the first surface being provided with one or more holes used for inserting test tubes; one ends of the first supporting surface and the second supporting surface are connected with the first end and the second of the first surface respectively;
the base surface is connected with the first paste surface, the first paste surface is connected with the steady surface, and the steady surface is connected with the second paste surface, wherein connections of the surfaces are connections via the creases or the broken lines.

21. The test tube rack according to claim 20, wherein the base surface and the first surface both comprise the broken line or the crease respectively, and the base surface and the first surface can be folded and shrunk via the broken line or the crease.
